(19) United States
(12) Patent Application Publication
(10) Pub. No.: US 2016/0187845 A1
(43) Pub. Date: Jun. 30, 2016

(54) Image Forming Apparatus and Control Method

(71) Applicant: Brother Kogyo Kabushiki Kaisha, Nagoya-shi (JP)

(72) Inventors: Hideaki Deguchi, Nagoya-shi (JP); Keita Hironaka, Ohbu-shi (JP); Yusuke Ozaki, Nagoya-shi (JP)

(21) Appl. No.: 14/978,387

(22) Filed: Dec. 22, 2015

(30) Foreign Application Priority Data
Dec. 26, 2014 (JP) 2014-264619

(51) Int. Cl. G03G 15/16; G03G 21/20

(52) U.S. Cl. CPC G03G 21/20; G03G 15/1665

(57) ABSTRACT

An image forming apparatus includes a transfer device configured to transfer a developer image carried on an image carrier to a recording sheet, a humidity obtaining device configured to obtain a humidity, and a controller configured to apply a transfer voltage to the transfer device and change the transfer voltage on the basis of a transfer impedance and the humidity, the transfer impedance being obtained from the transfer voltage and a transfer current flowing through the transfer device while the recording sheet passes the transfer device.

### CROSS-REFERENCE TO RELATED APPLICATION

This application claims priority from Japanese Patent Application No. 2014-264619 filed on Dec. 26, 2014, the entire subject-matter of which is incorporated herein by reference.

### TECHNICAL FIELD

The disclosure relates to an image forming apparatus having a transfer device configured to transfer a developer image carried on an image carrier to a recording sheet, a control method of a transfer voltage to be applied to the transfer device, and a non-transitory computer-readable program for controlling the transfer voltage.

### BACKGROUND

There has been proposed an image forming apparatus having a plurality of photosensitive members, an intermediate transfer belt to which toner images are to be transferred from the respective photosensitive members, and a secondary transfer device configured to interpose a sheet between the secondary transfer device and the intermediate transfer belt and to transfer the toner images on the intermediate transfer belt to the sheet. According to this related-art, a transfer bias that is to be applied to the secondary transfer device is corrected on the basis of a temperature and humidity environment, a sheet width, and a transfer impedance of the secondary transfer device at a state where the sheet is not contacted to the secondary transfer device.

According to the above-described related art, however, since the transfer impedance of the secondary transfer device is detected at the state where the sheet is not contacted to the secondary transfer device, it is not possible to perform the control corresponding to a change in the transfer impedance when the sheet reaches the secondary transfer device.

### SUMMARY

Illustrative aspects of the disclosure perform a voltage control corresponding to a change in a transfer impedance while a recording sheet such as a sheet passes a transfer device such as a secondary transfer device.

According to one aspect, there is provided an image forming apparatus comprising: a transfer device configured to transfer a developer image carried on an image carrier to a recording sheet; a humidity obtaining device configured to obtain a humidity; and a controller configured to: apply a transfer voltage to the transfer device; and change the transfer voltage on the basis of a transfer impedance and the humidity, the transfer impedance being obtained from the transfer voltage and a transfer current flowing through the transfer device while the recording sheet passes the transfer device.

According to the above configuration, since the transfer voltage is changed on the basis of the humidity and the transfer impedance while the recording sheet passes the transfer device, it is possible to favorably perform the voltage control corresponding to the humidity and the change in the transfer impedance while the recording sheet passes the transfer device.

According to the disclosure, it is possible to perform the voltage control corresponding to a change in the transfer impedance while the recording sheet passes the transfer device.

### BRIEF DESCRIPTION OF THE DRAWINGS

FIG. 1 depicts a laser printer according to an illustrative embodiment of the disclosure;

FIG. 2 is a block diagram showing configurations of a controller and the like;

FIG. 3 depicts respective characteristic curves that are to be used when transferring a toner image to a first surface of a wide sheet;

FIG. 4 depicts respective characteristic curves that are to be used when transferring a toner image to a second surface of the wide sheet;

FIG. 5 depicts respective characteristic curves that are to be used when transferring a toner image to a first surface of a narrow sheet;

FIG. 6 depicts respective characteristic curves that are to be used when transferring a toner image to a second surface of the narrow sheet; and

FIG. 7 is a flowchart showing operations of the controller.

### DETAILED DESCRIPTION

Hereinafter, an illustrative embodiment of the disclosure will be described in detail with reference to the drawings. In below descriptions, a schematic configuration of a laser printer 1, which is an example of image forming apparatus, will be first described and then the features of the disclosure will be described.

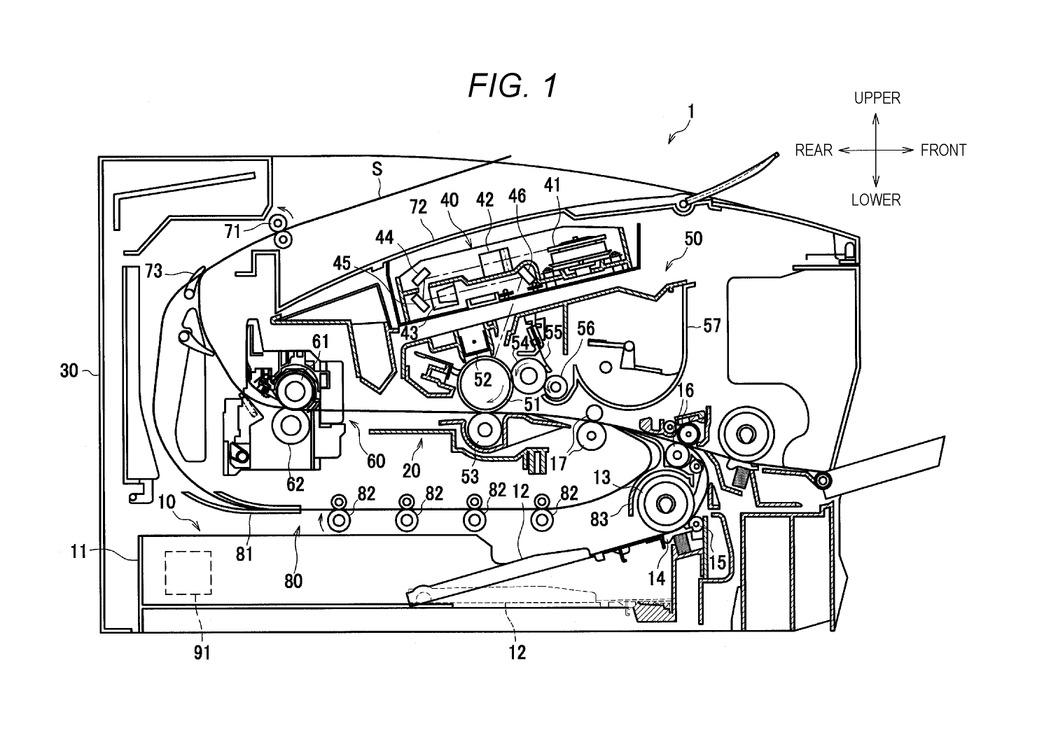

In the below descriptions, the directions are described in FIG. 1, the right side of the drawing sheet is referred to as ‘front side’, the left side of the drawing sheet is referred to as ‘rear side’, the front side of the drawing sheet is referred to as ‘left side’ and the inner side of the drawing sheet is referred to as ‘right side.’ Also, the upper and lower direction of the drawing sheet is referred to as ‘upper and lower direction.’

As shown in FIG. 1, the laser printer 1 has a feeder device 10 configured to feed a sheet S, which is an example of the recording sheet, an image forming device 20 configured to form an image on the sheet S, and the like in a main body casing 30, which is a housing. The image forming device 20 has a scanner device 40, a process cartridge 50, a fixing device 60, and the like.

The feeder device 10 has a sheet feeding tray 11 detachably mounted to a bottom part of the main body casing 30 and a sheet pressing plate 12 arranged at a front part in the sheet feeding tray 11. Also, the feeder device 10 has a feeder roller 13 and a sheet feeding pad 14 arranged above a front end portion of the sheet feeding tray 11, and paper dust removing rollers 15, 16 arranged at a downstream side with respect to the feeder roller 13 in a conveying direction of the sheet S. Further, the feeder device 10 has register rollers 17 arranged at a downstream side with respect to the paper dust removing rollers 15, 16 in the conveying direction of the sheet S.

In the feeder device 10, the sheet S accommodated in the sheet feeding tray 11 is inclined toward the feeder roller 13 by the sheet pressing plate 12. The sheet S interposed between the feeder roller 13 and the sheet feeding pad 14 is conveyed to the image forming device 20 via the paper dust removing rollers 15, 16 and the register rollers 17 by rotation of the feeder roller 13.

The scanner device 40 is arranged at an upper part in the main body casing 30, and has a laser light emitting device (not shown), a polygon mirror 41, lenses 42, 43, and reflectors 44, 45, 46. In the scanner device 40, a laser beam passes a path shown with the dashed-dotted line, and is scanned onto a surface of a photosensitive drum 51 disposed in the process cartridge 50 at high speed.

The process cartridge 50 is arranged below the scanner device 40, and is detachably mounted to the main body casing 30. The process cartridge 50 has a photosensitive drum 51, which is an example of the image carrier, a scorotron-type charger 52, a transfer roller 53, which is an example of the transfer device, a developing roller 54, a layer thickness regulation blade 55, a supply roller 56 and a toner hopper 57.

In the process cartridge 50, a surface of the photosensitive drum 51 charged by the scorotron-type charger 52 is exposed by the laser beam emitted from the scanner device 40, so that an electrostatic latent image is formed on the surface of the photosensitive drum 51. Toner in the toner hopper 57, which is an example of the developer, is supplied to the electrostatic latent image through the supply roller 56 and the developing roller 54, so that a toner image is formed on the surface of the photosensitive drum 51. Thereafter, when the sheet S is conveyed between the photosensitive drum 51 and the transfer roller 53, a transfer voltage is applied to the transfer roller 53, so that the toner image carried on the surface of the photosensitive drum 51 is transferred to a surface of the sheet S by the transfer roller 53 and an image is formed on the surface of the sheet S.

The fixing device 60 has a heating roller 61 configured to heat and fix the toner image transferred to the sheet S and a pressing roller 62 configured to interpose and press the sheet S between the pressing roller and the heating roller 61. The fixing device 60 is arranged at a downstream side with respect to the process cartridge 50 in the conveying direction of the sheet S. The sheet S heat-fixed in the fixing device 60 is discharged onto a sheet discharge tray 72 outside the main body casing 30 by sheet discharge rollers 71.

Upon duplex printing of forming images on both surfaces of the sheet S, before discharging the entire sheet S onto the sheet discharge tray 72, the sheet discharge rollers 71 are reversely rotated to return the sheet S into the main body casing 30. The sheet S returned into the main body casing 30 passes a rear side of the fixing device 60 as a flapper 73 is switched, and is then delivered to a re-conveyance mechanism 80, which is an example of the re-conveyance device.

The re-conveyance mechanism 80 is a mechanism configured to turn over the sheet S on which the toner image has been heat-fixed on the first surface in the fixing device 60 and to re-convey the sheet S between the photosensitive drum 51 and the transfer roller 53, and is disposed between the image forming device 20 and the sheet feeding tray 11. The re-conveyance mechanism 80 has a guide member 81 configured to switch a direction of the sheet S, which passes the rear side of the fixing device 60 and is conveyed downwards, to a forward direction, and a plurality of return rollers 82 configured to return the sheet S guided by the guide member 81 to a front side of the photosensitive drum 51 and provided in parallel back and forth.

The sheet S discharged from the re-conveyance mechanism 80 is guided toward the register rollers 17 with being turned over by a guide 83 disposed in front of the re-conveyance mechanism 80. Thereby, after a tip of the sheet S is aligned by the register rollers 17, the sheet S is again conveyed between the photosensitive drum 51 and the transfer roller 53, and the toner image on the surface of the photosensitive drum 51 is transferred to a second surface of the sheet S.

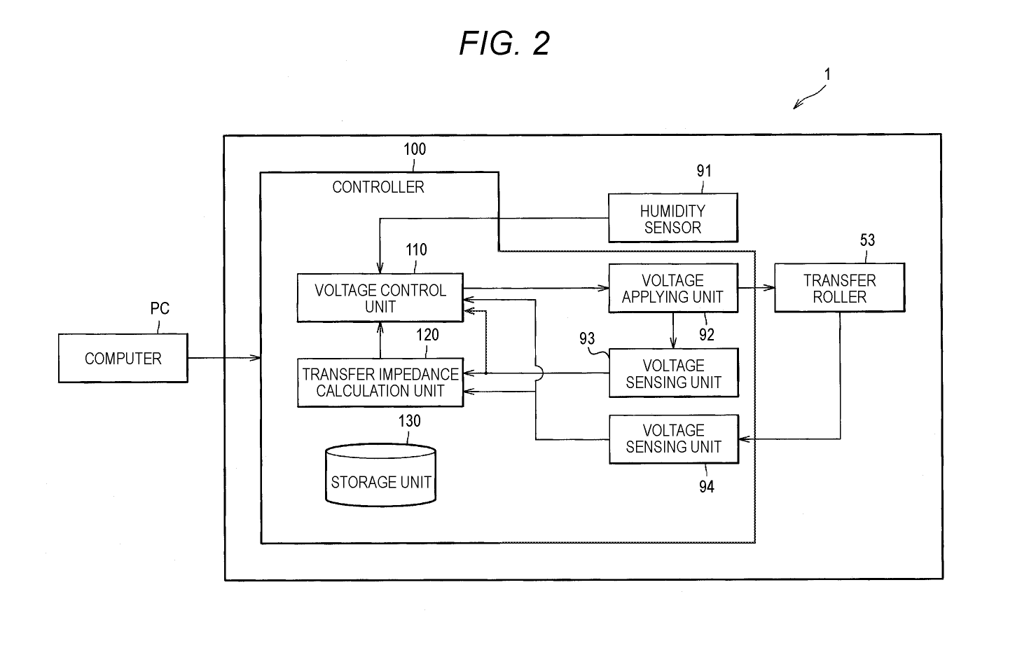

In order to control a transfer voltage that is to be applied to the transfer roller 53, the laser printer 1 has a humidity sensor 91, which is an example of the humidity obtaining device, a controller 100, as shown in FIG. 2.

The controller 100 has a CPU, a RAM, a ROM and an input/output circuit, and is configured to execute a printing control by performing a variety of calculation processing on the basis of a printing job to be input from an external computer PC, information to be input from the humidity sensor 91 and a program and data stored in the ROM and the like. In other words, the controller 100 may be configured by a processor and a memory storing instructions which, when executed by the processor, cause the image forming apparatus to perform predetermined operations. The controller 100 is configured to execute, as modes of the transfer control, a first surface transfer mode in which a toner image is to be transferred to a first surface of the sheet S and a second surface transfer mode in which a toner image is to be transferred to a second surface of the re-conveyed sheet S.

Specifically, when a content of the printing job is one-sided printing, the controller 100 executes the first surface transfer mode from start of the printing control to end of the printing control, and when a content of the printing job is a duplex printing, the controller 100 regularly, for example, alternately repeatedly executes the first surface transfer mode and the second surface transfer mode from start of the printing control to end of the printing control.

The controller 100 has a voltage applying unit 92, a voltage sensing unit 93 and a current sensing unit 94. The controller 100 also has, as a unit configured to control the transfer voltage to be applied to the transfer roller 53, a voltage control unit 110, a transfer impedance calculation unit 120 and a storage unit 130. In other words, the controller 100 is configured to operate on the basis of a program stored in the storage unit 130, thereby functioning as the voltage applying unit 92, the voltage sensing unit 93, the current sensing unit 94, the voltage control unit 110 and the transfer impedance calculation unit 120.

The voltage applying unit 92 has a circuit configured to apply a transfer voltage to the transfer roller 53, and is controlled by the voltage control unit 110. In the meantime, as the voltage applying unit 92, a circuit configured to generate a transfer voltage on the basis of a PWM (Pulse Width Modulation) signal may be adopted.

The voltage sensing unit 93 functions as a sensor configured to detect a transfer voltage that is to be applied to the transfer roller 53, and is configured to output the detected transfer voltage to the voltage control unit 110 and the transfer impedance calculation unit 120.

The current sensing unit 94 functions a sensor configured to detect a transfer current flowing through the transfer roller 53, and is configured to output the detected transfer current to the voltage control unit 110 and the transfer impedance calculation unit 120.

The transfer impedance calculation unit 120 has a function of executing a transfer impedance calculation control of dividing a transfer voltage, which is to be input from the voltage sensing unit 93, by a transfer current, which is to be input from the current sensing unit 94, thereby calculating a transfer impedance. Specifically, the transfer impedance calculation unit 120 is configured to execute a plurality of the transfer impedance calculation controls with a predetermined control cycle from feeding start of one sheet S to printing completion so as to perform the transfer impedance calculation control while the sheet S passes the transfer roller 53. In the meantime, the control cycle may be set to a time shorter than a time period after a tip of the sheet S reaches a transfer position between the transfer roller 53 and the photosensitive drum 51 until a rear end of the sheet S reaches the transfer position. More specifically, the control cycle may be set to a time shorter than a time period after a tip of the sheet S reaches a transfer position between the transfer roller 53 and the photosensitive drum 51 until an image area of the sheet S reaches the transfer position.

When the transfer impedance calculation unit 120 calculates the transfer impedance, it outputs the calculated transfer impedance to the voltage control unit 110.

The voltage control unit 110 has functions of obtaining a width of the sheet S, which is to be printed on the basis of a printing job output from the computer PC and stored in the storage unit 130, from the printing job, and obtaining information indicating to which surface of the sheet S the toner image is currently transferred. Specifically, for example, when a duplex printing of the sheet S having a width equivalent to a letter size is designated in the printing job, the voltage control unit 110 obtains a sheet width equivalent to the letter size from the printing job. Also, the voltage control unit 110 obtains the information of the respective transfer modes in the duplex printing, specifically, the information indicating at which mode of the first surface transfer mode and the second surface transfer mode the controller 100 is currently performing the transfer, from the printing job.

Also, the voltage control unit 110 has functions of obtaining the humidity from the humidity sensor 91, obtaining the transfer current from the current sensing unit 94 and obtaining the transfer impedance from the transfer impedance calculation unit 120. The voltage control unit 110 is configured to execute a voltage control of controlling a signal to be supplied to the voltage applying unit 92 on the basis of the obtained humidity, sheet width, transfer mode and transfer impedance, thereby changing the transfer voltage.

Specifically, the voltage control unit 110 is configured to select one of a plurality of characteristic curves, which is an example of the plurality of functions, stored in the storage unit 130 on the basis of the humidity, the sheet width and the transfer mode, and to set a target current value of the transfer current on the basis of the selected one characteristic curve and the transfer impedance. The voltage control unit 110 is configured to control a signal to be supplied to the voltage applying unit 92 such that the transfer current obtained from the current sensing unit 94 becomes the target current value, thereby controlling the transfer voltage to be applied from the voltage applying unit 92 to the transfer roller 53. The voltage control unit 110 is configured to control the transfer voltage every predetermined control cycle such that the transfer current becomes the target current value.

In the meantime, according to the illustrative embodiment, the voltage control unit 110 functions as a first unit configured to obtain the humidity, a second unit configured to apply the transfer voltage to the transfer roller 53, a third unit configured to obtain the transfer current flowing through the transfer roller 53, and a fourth unit configured to change the transfer voltage on the basis of the humidity and the transfer impedance calculated from the transfer voltage and the transfer current while the sheet S passes the transfer roller 53.

In the storage unit 130, the plurality of characteristic curves, the program for operating the voltage control unit 110 and the transfer impedance calculation unit 120, and the like are stored. In the meantime, the plurality of characteristic curves can be appropriately set by tests, simulations and the like.

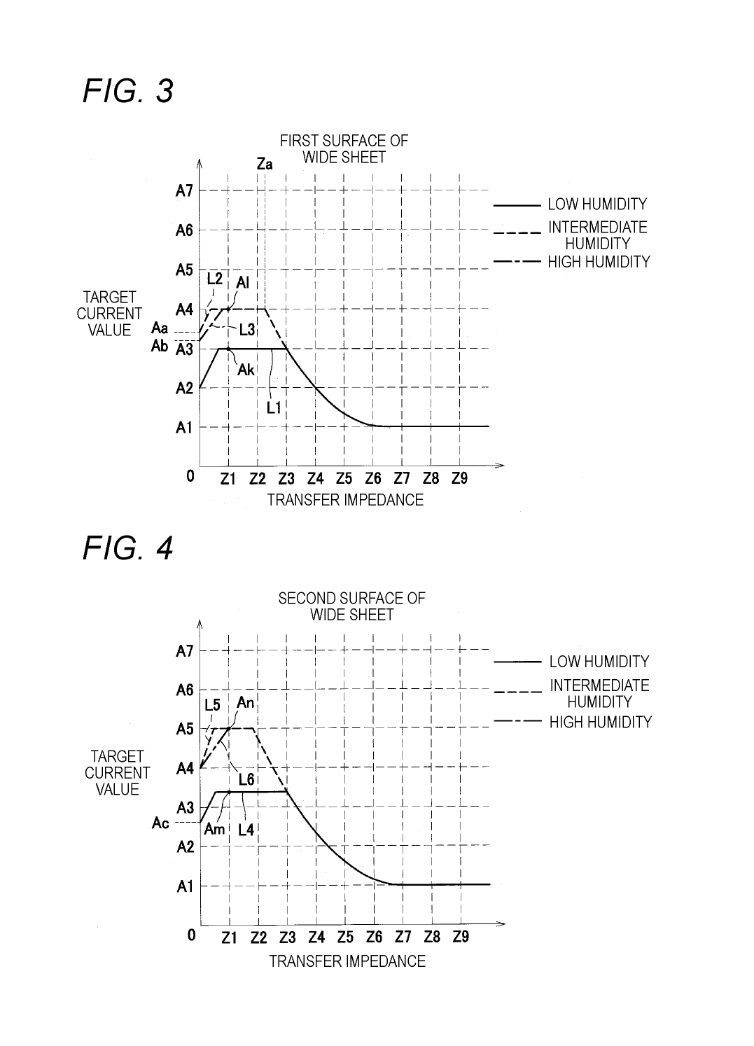

Specifically, as shown in FIGS. 3 to 6, the storage unit 130 stores therein a plurality of characteristic curves L1 to L12 indicative of a relation between the transfer impedance and the target current value of the transfer current, in association with the humidity, the sheet width and the transfer mode. In the meantime, respective values A1, A2, • • • of the target current value and respective values Z1, Z2, • • • of the transfer impedance shown in FIGS. 3 to 6 becomes larger as the last number is larger.

The first characteristic curve L1, the second characteristic curve L2 and the third characteristic curve L3 shown in FIG. 3 are the characteristic curves corresponding to the three types of humidity ranges when the sheet width is a wide sheet and the transfer mode is the first surface transfer mode. Here, when a width of the sheet S is a predetermined width or greater, the sheet width is set to the wide sheet. An example of the wide sheet is a letter size that is a transferable maximum width.

Specifically, the first characteristic curve L1 shown with the solid line is a characteristic curve when the humidity is a low humidity, the second characteristic curve L2 shown with the broken line is a characteristic curve when the humidity is an intermediate humidity, and the third characteristic curve L3 shown with the dashed-dotted line is a characteristic curve when the humidity is a high humidity. Here, the low humidity can be set to a humidity range that is low to some extent, the intermediate humidity can be set to a humidity range greater than the humidity range of the low humidity, and the high humidity can be set to a humidity range greater than the humidity range of the intermediate humidity.

The first characteristic curve L1 is set such that the target current value is a value A2 when the transfer impedance is zero (0), the target current value linearly increases from the value A2 toward a value A3 as the transfer impedance increases in a range of the transfer impedance from zero (0) to a value Z3, and the target current value is kept at the value A3 after it reaches the value A3. Also, the first characteristic curve L1 is set such that when the transfer impedance is equal to or greater than the value Z3, the target current value gradually decreases in a curved line and gradually reaches a constant value A1 as the transfer impedance increases. In the meantime, the transfer impedance does not actually reach zero (0). However, zero (0) is set on the characteristic curve.

The second characteristic curve L2 is set such that the target current value is a substantially intermediate value Aa between the values A3 and A4 when the transfer impedance is zero (0), the target current value linearly increases from the value Aa toward the value A4 as the transfer impedance increases in a range of the transfer impedance from zero (0) to a value Za slightly greater than the value Z2, and the target current value is kept at the value A4 after it reaches the value A4. Also, the second characteristic curve L2 is set such that when the transfer impedance is equal to or greater than the value Za, the target current value gradually decreases in a curved line and gradually reaches the constant value A1 as the transfer impedance increases. Specifically, the second characteristic curve L2 coincides with the first characteristic curve L1 when the transfer impedance is equal to or greater than the value Z3.

The third characteristic curve L3 is set such that the target current value is a value Ab smaller than the target current value Aa of the second characteristic curve L2 when the transfer impedance is zero (0), and the target current value linearly increases from the value Ab toward the value A4 as the transfer impedance increases from zero. Also, the third characteristic curve L3 coincides with the second characteristic curve L2 after the target current value reaches the value A4.

The fourth characteristic curve L4, the fifth characteristic curve L5 and the sixth characteristic curve L6 shown in FIG. 4 are the characteristic curves corresponding to the three types of humidity ranges when the sheet width is a wide sheet and the transfer mode is the second surface transfer mode. Specifically, the fourth characteristic curve L4 shown with the solid line is a characteristic curve when the humidity is the low humidity, the fifth characteristic curve L5 shown with the broken line is a characteristic curve when the humidity is the intermediate humidity, and the sixth characteristic curve L3 shown with the dashed-dotted line is a characteristic curve when the humidity is the high humidity.

The fourth characteristic curve L4 is a characteristic curve that changes in the substantially same tendency as the first characteristic curve L1, i.e., a characteristic curve where as the transfer impedance increases, the target current value changes to increase, to be constant, to decrease and to be constant. The fourth characteristic curve L4 is set such that the target current value is greater than the first characteristic curve L1 when the transfer impedance is equal to or smaller than the value Z3. Specifically, for example, when the transfer impedance is zero (0) in the first characteristic curve L1, the target current value is the value A2. In contrast, when the transfer impedance is zero (0) in the fourth characteristic curve L4, the target current value is a value Ac greater than the value A2.

As shown in FIGS. 3 and 4, in the first characteristic curve L1 that is to be selected when the humidity is the low humidity, the sheet width is the wide sheet, and the transfer mode is the first surface transfer mode, when the transfer impedance is a first value (for example, Z1) equal to or smaller than the value Z3, the target current value is a first current value (for example, Ak). In contrast, in the fourth characteristic curve L4 that is to be selected when the same conditions are set for the humidity and the sheet width and only the transfer mode is different (the second surface transfer mode), when the transfer impedance is the first value (for example, Z1), the target current value is a second current value (for example, Am) greater than the first current value (for example, Ak).

The fifth characteristic curve L5 is a characteristic curve that changes in the substantially same tendency as the second characteristic curve L2, and is set such that the target current value becomes greater than the second characteristic curve L2 when the transfer impedance is equal to or smaller than the value Z3. Specifically, for example, when the transfer impedance is zero (0) in the second characteristic curve L2, the target current value is the value Aa smaller than the value A4. In contrast, when the transfer impedance is zero (0) in the fifth characteristic curve L5, the target current value is the value A4.

The sixth characteristic curve L6 is a characteristic curve that changes in the substantially same tendency as the third characteristic curve L3, and is set such that the target current value becomes greater than the third characteristic curve L3 when the transfer impedance is equal to or smaller than the value Z3. Specifically, for example, when the transfer impedance is zero (0) in the third characteristic curve L3, the target current value is the value Ab smaller than the value A4. In contrast, when the transfer impedance is zero (0) in the sixth characteristic curve L6 the target current value is the value A4.

As shown in FIGS. 3 and 4, in the third characteristic curve L3 that is to be selected when the humidity is the low humidity, the sheet width is the wide sheet, and the transfer mode is the first surface transfer mode, when the transfer impedance is the first value (for example, Z1) equal to or smaller than the value Z3, the target current value is a first current value (for example, A1). In contrast, in the sixth characteristic curve L6 that is to be selected when the same conditions are set for the humidity and the sheet width and only the transfer mode is different (the second surface transfer mode), when the transfer impedance is the first value (for example, Z1), the target current value is a second current value (for example, An) greater than the first current value (for example, A1).

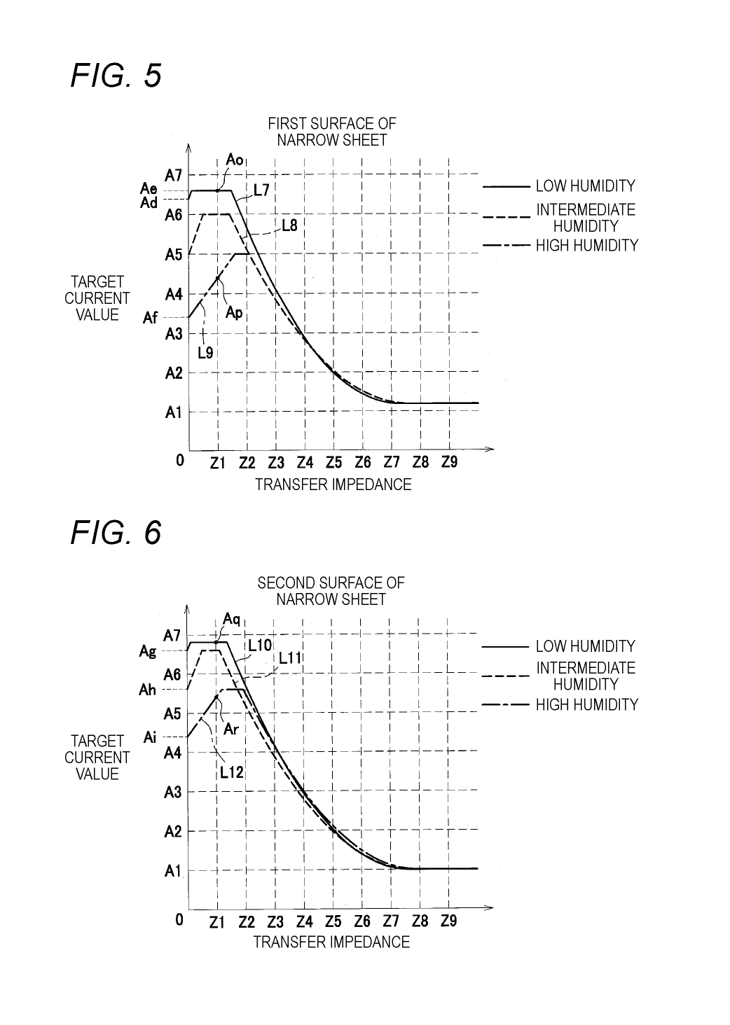

The seventh characteristic curve L7, the eighth characteristic curve L8 and the ninth characteristic curve L9 shown in FIG. 5 are the characteristic curves corresponding to the three types of humidity ranges when the sheet width is a narrow sheet and the transfer mode is the first surface transfer mode. Here, when a width of the sheet S is smaller than a predetermined width, the sheet width is set to the narrow sheet. An example of the narrow sheet is a postcard having a first width smaller than the transferable maximum width.

Specifically, the seventh characteristic curve L7 shown with the solid line is a characteristic curve when the humidity is the low humidity, the eighth characteristic curve L8 shown with the broken line is a characteristic curve when the humidity is the intermediate humidity, and the ninth characteristic curve L9 shown with the dashed-dotted line is a characteristic curve when the humidity is the high humidity. The respective characteristic curves L7 to L9 change in the substantially same tendency as the respective characteristic curves L1 to L3 corresponding to each humidity when the sheet width is the wide sheet. However, a width of the change in the target current value is greater than each of the characteristic curves L1 to L3.

Specifically, the seventh characteristic curve L7 is set such that as the transfer impedance increases from zero (0), the target current value increases from a value Ad between the values A6 and A7 toward a value Ae greater than the value Ad and smaller than the value A7, becomes the constant value Ae, decreases and then gradually becomes a constant value. The eighth characteristic curve L8 is set such that as the transfer impedance increases from zero (0), the target current value increases from a value A5 toward the value A6, becomes the constant value A6 and then decreases, and substantially coincides with the seventh characteristic curve L7 after the transfer impedance becomes a value Z4. The ninth characteristic curve L9 is set such that as the transfer impedance increases from zero (0), the target current value increases from a value Af between the values A3 and A4 toward the value A5 and becomes the constant value A5, and substantially coincides with the eighth characteristic curve L8 after the transfer impedance becomes the value Z2.

When the transfer impedance is equal to or smaller than the value Z4, the target current value of the seventh characteristic curve L7 corresponding to the low humidity is greater than the eighth characteristic curve L8 corresponding to the intermediate humidity. Also, when the transfer impedance is equal to or smaller than the value Z2, the target current value of the eighth characteristic curve L8 corresponding to the intermediate humidity is greater than the ninth characteristic curve L9 corresponding to the high humidity.

That is, in the characteristic curve (for example, L7) that is to be selected when the humidity is a first humidity (for example, the low humidity), the sheet width is the narrow sheet and the transfer mode is the first surface transfer mode, when the transfer impedance is a first value (for example, Z1) equal to or smaller than a predetermined value (for example, Z4), the target current value is a first current value (for example, Ao). In contrast, in the characteristic curve (for example, L8) that is to be selected when the same conditions are set for the sheet width and the transfer mode and only the humidity is different, specifically, the humidity is a second humidity (for example, the intermediate humidity) greater than the first humidity, when the transfer impedance is the first value (for example, Z1), the target current value is a second current value (for example, Ap) smaller than the first current value (for example, Ao).

The tenth characteristic curve L10, the eleventh characteristic curve L11 and the twelfth characteristic curve L12 shown in FIG. 6 are the characteristic curves corresponding to the three types of humidity ranges when the sheet width is a narrow sheet and the transfer mode is the second surface transfer mode. Specifically, the tenth characteristic curve L10 shown with the solid line is a characteristic curve when the humidity is the low humidity, the eleventh characteristic curve L11 shown with the broken line is a characteristic curve when the humidity is the intermediate humidity, and the twelfth characteristic curve L12 shown with the dashed-dotted line is a characteristic curve when the humidity is the high humidity.

The tenth characteristic curve L10 is a characteristic curve that changes in the substantially tendency as the seventh characteristic curve L7, and is set such that when the transfer impedance is equal to or smaller than the value Z3, the target current value becomes greater than the seventh characteristic curve L7. Specifically, for example, when the transfer impedance is zero (0) in the seventh characteristic curve L7, the target current value is a value Ad (a value closer to the value A6 than the value A7). However, when the transfer impedance is zero (0) in the tenth characteristic curve L10, the target current value is a value Ag (a value closer to the value A7 than the value A6) greater than the value Ad.

As shown in FIGS. 5 and 6, in the characteristic curve L7 that is to be selected when the humidity is the low humidity, the sheet width is the narrow sheet and the transfer mode is the first surface transfer mode, when the transfer impedance is a first value (for example, Z1) equal to or smaller than a value Z3, the target current value is a first current value (for example, Ao). In contrast, in the tenth characteristic curve L10 that is to be selected when the same conditions are set for the humidity and the sheet width and the transfer mode is the second surface transfer mode, when the transfer impedance is the first value (for example, Z1), the target current value is a second current value (for example, Aq) greater than the first current value (for example, Ao).

The eleventh characteristic curve L11 is a characteristic curve that changes in the substantially tendency as the eighth characteristic curve L8, and is set such that when the transfer impedance is equal to or smaller than the value Z3, the target current value becomes greater than the eighth characteristic curve L8. Specifically, for example, when the transfer impedance is zero (0) in the eighth characteristic curve L8, the target current value is the value A5. However, when the transfer impedance is zero (0) in the eleventh characteristic curve L11, the target current value is a value Ah greater than the value A5.

The twelfth characteristic curve L12 is a characteristic curve that changes in the substantially tendency as the ninth characteristic curve L9, and is set such that when the transfer impedance is equal to or smaller than the value Z3, the target current value becomes greater than the ninth characteristic curve L9. Specifically, for example, when the transfer impedance is zero (0) in the ninth characteristic curve L9, the target current value is a value Af smaller than the value A4. However, when the transfer impedance is zero (0) in the twelfth characteristic curve L12, the target current value is a value Ai greater than the value A4.

As shown in FIGS. 5 and 6, in the ninth characteristic curve L9 that is to be selected when the humidity is the high humidity, the sheet width is the narrow sheet and the transfer mode is the first surface transfer mode, when the transfer impedance is a first value (for example, Z1) equal to or smaller than a value Z3, the target current value is a first current value (for example, Ap). In contrast, in the twelfth characteristic curve L12 that is to be selected when the same conditions are set for the humidity and the sheet width and the transfer mode is the second surface transfer mode, when the transfer impedance is the first value (for example, Z1), the target current value is a second current value (for example, Ar) greater than the first current value (for example, Ap).

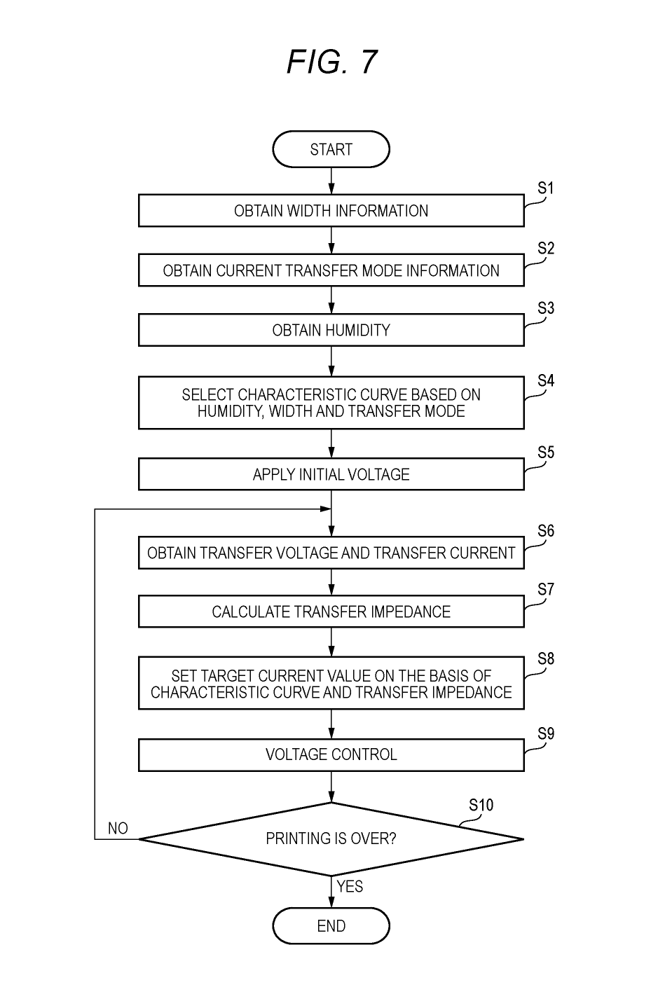

In the below, operations of the controller 100 are described in detail with reference to a flowchart shown in FIG. 7. In the meantime, the controller 100 executes the flowchart shown in FIG. 7 after the printing on the first surface or the second surface of the sheet S starts until the printing is completed. Specifically, the controller 100 starts the control of the flowchart (START) when starting the printing on the first surface of the sheet S, for example, and ends the control of the flowchart (END) when finishing the printing on the first surface of the sheet S. Thereafter, the controller 100 again starts the control of the flowchart (START) when starting the printing on the second surface of the sheet S, and ends the control of the flowchart (END) when finishing the printing on the second surface of the sheet S.

As shown in FIG. 7, when starting the printing on the sheet S (START), the controller 100 first obtains the width information of the sheet S from the printing job (S1). After step S1, the controller 100 obtains a current transfer mode from the printing job (S2).

After step S2, the controller 100 obtains the humidity from the humidity sensor 91 (S3), and selects one of the characteristic curves L1 to L12 on the basis of the obtained humidity, sheet width and transfer mode (S4).

After step S4, the controller 100 applies a transfer voltage corresponding to a preset initial value to the transfer roller 53 through the voltage applying unit 92 so as to obtain an initial transfer current necessary for the current control (S5). After step S5, the controller 100 obtains the transfer voltage and the transfer current from the voltage sensing unit 93 and the current sensing unit 94 (S6), and divides the transfer voltage by the transfer current to calculate the transfer impedance (S7).

After step S7, the controller 100 sets the target current value on the basis of the one characteristic curve selected in step S4 and the transfer impedance calculated in step S7 (S8).

After step S8, the controller 100 executes the voltage control of changing the transfer voltage such that the detected transfer current becomes the set target current value (S9). After step S9, the controller 100 determines whether the printing on the sheet S is over (S10).

When it is determined in step S10 that the printing is not over (No), the controller 100 returns to the processing of step S6. Here, since the control cycle from step S6 to step S10 is set to the time shorter than the time period after the tip of the sheet S reaches the transfer position until the rear end of the sheet S reaches the transfer position, as described above, the transfer impedance is calculated and the transfer voltage is changed while each sheet S passes the transfer roller 53. When it is determined in step S10 that the printing is over (Yes), the controller 100 ends the control.

According to the above illustrative embodiment, following effects can be accomplished.

Since the transfer voltage is changed on the basis of the transfer impedance and the humidity while the sheet S passes the transfer roller 53, it is possible to favorably perform the voltage control corresponding to the humidity and the change in the transfer impedance while the sheet S passes the transfer roller 53.

Also, according to the illustrative embodiment, since the transfer voltage is changed, taking into consideration the conditions of the width of the sheet S and the transfer mode, too, it is possible to more favorably perform the voltage control. In particular, since an amount of moisture of the sheet S changes upon the transfer of the first surface before the sheet S passes through the fixing device 60 and upon the transfer of the second surface after the sheet S passes through the fixing device 60, it is possible to favorably perform the voltage control corresponding to the change in the amount of moisture of the sheet S by changing the transfer voltage, taking into consideration each transfer mode, too.

The disclosure is not limited to the illustrative embodiment and can be implemented in a variety of forms, as exemplified below.

In the above illustrative embodiment, the voltage sensing unit 93 is provided. However, the disclosure is not limited thereto, and the voltage sensing unit may not be provided. That is, since it is possible to calculate the transfer voltage to be applied from the detected transfer current, it is possible to calculate the transfer impedance even when the transfer voltage is not detected by the voltage sensing unit.

In the above illustrative embodiment, the photosensitive drum 51 has been exemplified as the image carrier. However, the disclosure is not limited thereto. For example, the image carrier may be an intermediate transfer belt to which the toner image on the photosensitive drum is to be transferred.

In the above illustrative embodiment, the transfer roller 53 has been exemplified as the transfer device. However, the disclosure is not limited thereto. For example, the transfer device may be any member to which the transfer bias is to be applied, such as a conductive brush, a conductive plate spring and the like.

In the above illustrative embodiment, the sheet S such as thick sheet, postcard, thin sheet and the like has been exemplified as the recording sheet. However, the disclosure is not limited thereto. For example, the recording sheet may be an OHP sheet.

In the above illustrative embodiment, the characteristic curve has been exemplified as the function. However, the disclosure is not limited thereto. For example, an equation or a table in which the transfer impedance and the target current value are associated with each other is also possible. Also, the function is expressed as a control map.

In the above illustrative embodiment, the member having the heating roller 61 has been exemplified as the fixing device 60. However, the disclosure is not limited thereto. For example, a member including a heat source and a nip member arranged in a fixing belt and a pressing member configured to interpose the fixing belt between the nip member and the pressing member is also possible.

In the above illustrative embodiment, the disclosure is applied to the laser printer 1. However, the disclosure is not limited thereto. For example, the disclosure can also be applied to the other image forming apparatuses such as a copier, a complex machine and the like.

In the above illustrative embodiment, the transfer current is detected by the current sensing unit 94 separately provided from the controller 100. However, the disclosure is not limited thereto. For example, a current detection device configured to detect the transfer current may be provided in the controller.

What is claimed is:

1. An image forming apparatus comprising:
a transfer device configured to transfer a developer image carried on an image carrier to a recording sheet;
a humidity obtaining device configured to obtain a humidity; and
a controller configured to:
apply a transfer voltage to the transfer device; and
change the transfer voltage on the basis of a transfer impedance and the humidity, the transfer impedance being obtained from the transfer voltage and a transfer current flowing through the transfer device while the recording sheet passes the transfer device.

2. The image forming apparatus according to claim 1, further comprising:
a memory stores therein a plurality of functions, each of which indicates a relation between the transfer impedance and a target current value of the transfer current, in association with the humidity,
wherein the controller is configured to:
select one of the plurality of functions on the basis of the humidity; and
change the transfer voltage on the basis of the selected one function.

3. The image forming apparatus according to claim 1, wherein the controller is configured to change the transfer voltage on the basis of the transfer impedance, the humidity and a width of the recording sheet.

4. The image forming apparatus according to claim 1, further comprising:
a memory stores therein a plurality of functions, each of which indicates a relation between the transfer impedance and a target current value of the transfer current, in association with the humidity and a width of the recording sheet,
wherein the controller is configured to:
select one of the plurality of functions on the basis of the humidity and the width of the recording sheet; and
change the transfer voltage on the basis of the selected one function.

5. The image forming apparatus according to claim 4,
wherein in a function that is to be selected when the humidity is a first humidity and the width of the recording sheet is a first width smaller than a transferable maximum width, when the transfer impedance is a first value that is equal to or smaller than a predetermined value, the target current value is a first current value, and
wherein in a function that is to be selected when the humidity is a second humidity greater than the first humidity and the width of the recording sheet is the first width, when the transfer impedance is the first value, the target current value is a second current value smaller than the first current value.

6. The image forming apparatus according to claim 4, further comprising:
a fixing device configured to heat and fix the developer image on the recording sheet; and
a re-conveyance device configured to re-convey the recording sheet having passed through the fixing device to the transfer device, and
wherein the controller is configured to:
execute a first surface transfer mode, in which a developer image is to be transferred to a first surface of the recording sheet, and a second surface transfer mode, in which a developer image is to be transferred to a second surface of the re-conveyed recording sheet; and
change the transfer voltage on the basis of the transfer impedance, the humidity, the width of the recording sheet and the transfer mode.

7. The image forming apparatus according to claim 6,
wherein in the memory, the functions are stored in association with the humidity, the width of the recording sheet and the transfer mode, and
wherein the controller is configured to select one of the plurality of functions on the basis of the humidity, the width of the recording sheet and the transfer mode.

8. The image forming apparatus according to claim 7,
wherein in a function that is to be selected when the humidity is a first humidity, the width of the recording sheet is a first width smaller than a transferable maximum width and the transfer mode is the first surface transfer mode, when the transfer impedance is a first value equal to or smaller than a predetermined value, the target current value is a first current value, and
wherein in a function that is to be selected when the humidity is the first humidity, the width of the recording sheet is the first width and the transfer mode is the second surface transfer mode, when the transfer impedance is the first value, the target current value is a second current value greater than the first current value.

9. The image forming apparatus according to claim 4,
wherein when the humidity is a first humidity and the width of the recording sheet is a first width that is smaller than a transferable maximum width, the controller is configured to select a function having a first characteristic curve, the first characteristic curve being set such that the target current value is a first current value when the transfer impedance is a first value that is equal to or smaller than a predetermined value, and
wherein when the humidity is a second humidity that is greater than the first humidity and the width of the recording sheet is the first width, the controller is configured to select a function having a second characteristic curve, the second characteristic curve being set such that the target current value is a second current value that is smaller than the first current value when the transfer impedance is the first value.

10. The image forming apparatus according to claim 9,
wherein the first characteristic curve is set such that as the transfer impedance increases from zero, the target current value increases from a first value toward a second value, becomes a constant value after the target current value reaches the second value, decreases and then gradually becomes a second constant value, and
wherein the second characteristic curve is set such that as the transfer impedance increases from zero, the target current value increases from a first value toward a second value, becomes a constant value after the target current value reaches the first constant value, decreases and then substantially coincides with the first characteristic curve, the first value of the second characteristic curve being smaller than the first value of the first characteristic curve.

11. A control method of a transfer voltage to be applied to a transfer device configured to transfer a developer image carried on an image carrier to a recording sheet, the control method comprising processes of:
obtaining a humidity;
applying a transfer voltage to the transfer device;
obtaining a transfer current flowing through the transfer device; and
changing the transfer voltage on the basis of a transfer impedance and the humidity, the transfer impedance being obtained from the transfer voltage and the transfer current while the recording sheet passes the transfer device.

12. The control method according to claim 11, further comprising:
selecting one of a plurality of functions on the basis of the humidity, each of the plurality of functions indicating a relation between the transfer impedance and a target current value of the transfer current, in association with the humidity; and
changing the transfer voltage on the basis of the selected one function.

13. The control method according to claim 11, wherein the changing the transfer voltage comprises changing the transfer voltage on the basis of the transfer impedance, the humidity and a width of the recording sheet.

14. The control method according to claim 11, further comprising:
selecting one of a plurality of functions on the basis of the humidity and the width of the recording sheet, each of the plurality of functions indicating a relation between the transfer impedance and a target current value of the transfer current, in association with the humidity and a width of the recording sheet; and
changing the transfer voltage on the basis of the selected one function.

15. The control method according to claim 14,
wherein in a function that is to be selected when the humidity is a first humidity and the width of the recording sheet is a first width smaller than a transferable maximum width, when the transfer impedance is a first value that is equal to or smaller than a predetermined value, the target current value is a first current value, and
wherein in a function that is to be selected when the humidity is a second humidity greater than the first humidity and the width of the recording sheet is the first width, when the transfer impedance is the first value, the target current value is a second current value smaller than the first current value.

16. The control method according to claim 14,
wherein when the humidity is a first humidity and the width of the recording sheet is a first width that is smaller than a transferable maximum width, the selecting one of a plurality of functions comprises selecting a function having a first characteristic curve, the first characteristic curve being set such that the target current value is a first current value when the transfer impedance is a first value that is equal to or smaller than a predetermined value, and
wherein when the humidity is a second humidity that is greater than the first humidity and the width of the recording sheet is the first width, the selecting one of a plurality of functions comprises selecting a function having a second characteristic curve, the second characteristic curve being set such that the target current value is a second current value that is smaller than the first current value when the transfer impedance is the first value.

17. The control method according to claim 16,
wherein the first characteristic curve is set such that as the transfer impedance increases from zero, the target current value increases from a first value toward a second value, becomes a constant value after the target current value reaches the second value, decreases and then gradually becomes a second constant value, and
wherein the second characteristic curve is set such that as the transfer impedance increases from zero, the target current value increases from a first value toward a second value, becomes a constant value after the target current value reaches the first constant value, decreases and then substantially coincides with the first characteristic curve, the first value of the second characteristic curve being smaller than the first value of the first characteristic curve.
